(19) United States
(12) Patent Application Publication
(10) Pub. No.: US 2010/0228524 A1
(43) Pub. Date: Sep. 9, 2010

(54) Sports analytics: use of a multi-dimensional database technology in the analysis of sports metrics related data

(76) Inventor: Bryan Jay Bain, Atlanta, GA (US)

Correspondence Address: Bryan J. Bain, 132 ROYAL ASSEMBLY DRIVE, CHARLESTON, SC, 29492, US

(21) Appl. No.: 12/399,336

(22) Filed: Mar. 6, 2009

(51) Int. Cl. G06F 15/00

(52) U.S. Cl. 702/182

(57) ABSTRACT

A method and apparatus for the processing and usage of a multi-dimensional database management system to support an analytic database focused on the analysis of player-based scoring for team and individual performance data. A multi-dimensional database is defined as having multiple perspectives (or dimensions) organized such that analysis of complex data sets is simplified for users of the system. Performance scoring metrics of athletes provides players, coaching staffs and office personnel with statistical information that represents true performance player by player in a specific sport. This data is by nature complex and comprised of extremely large data sets. Furthermore, the base set of facts only provides a certain level of information to these users, much more important is the derived information that can be surmised from these metrics. The definition and production of unique identifiers and metrics is a fundamental component of this apparatus.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The inventor has 15 years of experience with analytics and multi-dimensional database systems. Additionally the inventor is an avid sports fan and has been developing a sports-based analytical model for the past several years.

The 21^{st} century has seen an explosion of analytical technologies and methods proliferate in areas such as retail and sales analysis, supply chain, financial reporting and other areas where large data sets prevail. The inventor has been working with a variety of companies both large and small in the development of these analytical models in order for them to better understand their business. Performance management methodologies for other industries are nothing new and have become commonplace in the market. Currently, most corporations see these systems as necessary to compete in the global marketplace.

Essentially these models take large data sets (retail is a common, understandable example) and somehow computes usable information. A good example is retail point of sales (POS) information. Large retailers have hundreds of millions of transactions occur over the course of the year. From these hundreds of millions of rows of raw data the company must find a way to understand supply and demand, inventory planning, transportation, marketing, financial reporting and a myriad of other subject-matter based information in order to effectively run their company.

With the advent of multi-dimensional technology in the early 90s the analysis of these extremely large data sets became much easier. This technology is specifically designed to read these data sets and allow the systems to derive and users to extract vital, usable information.

The world of sports and sport management has also evolved in the last few years. Most upper level professional and college football games now employ instant replay technology based on advanced digital media. Basketball has used instant reply for even longer to assess the validity of last-second scoring. Baseball has long employed sophisticated database software to keep track of numerous base-level statistics.

From a true methodology perspective though most sports are still in the “pencil and clipboard” stage. Player performance is noted during game time and during post-game film reviews. Some analysis is also performed and “scored”, but these methods are severely hampered by the current technology employed to understand this growing inventory of data. Scoring systems for sports analysis are varied not only from sport to sport, but also from team to team, thus making it difficult for anyone to develop a particular technology that can address these challenges.

Because of this concurrence, the inventor has developed a generic system that can be used for any sport using this powerful and extremely flexible technology. The system can be developed and deployed for any sporting event whether team or individual based. The base metrics and derived data subsequently can be easily modified and maintained in order to keep current with personnel analysis requirements.

### BRIEF SUMMARY OF THE INVENTION

A method and apparatus for the processing and usage of a multi-dimensional database management system to support an analytic database focused on the analysis of player-based scoring for team and individual performance data. A multi-dimensional database is defined as having multiple perspectives (or dimensions) organized such that analysis of complex data sets is simplified for users of the system. Performance scoring metrics of athletes provides players, coaching staffs and office personnel with statistical information that represents true performance player by player in a specific sport. This data is by nature complex and comprised of extremely large data sets. Furthermore, the base set of facts only provides a certain level of information to these users, of much more value though is the derived information that can be surmised from these metrics. The definition and production of unique identifiers and metrics is the fundamental component of this apparatus.

### BRIEF DESCRIPTION OF THE SEVERAL VIEWS OF THE DRAWING

FIG. 1—Sample data flow diagram.

FIG. 2—Sample operational flow of the system.

FIG. 3—Sample input sheet.

FIG. 4—Sample metrics dimension.

FIG. 5—Sample metrics dimension showing derived information.

FIG. 6—Sample player dimension.

FIG. 7—Sample time dimension showing game performance over time and trending information by player and opportunity.

### DETAILED DESCRIPTION OF THE INVENTION

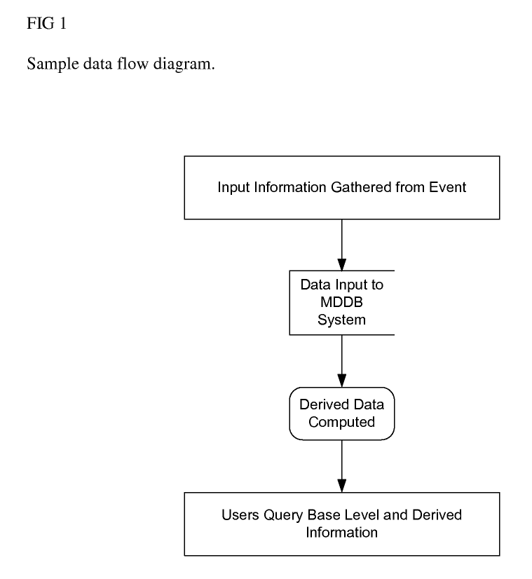

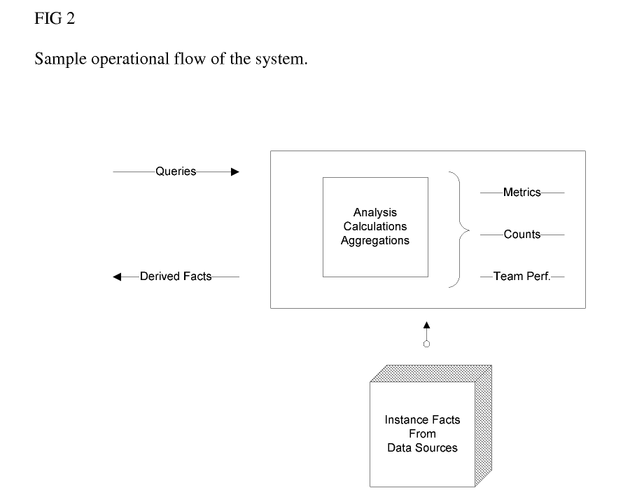

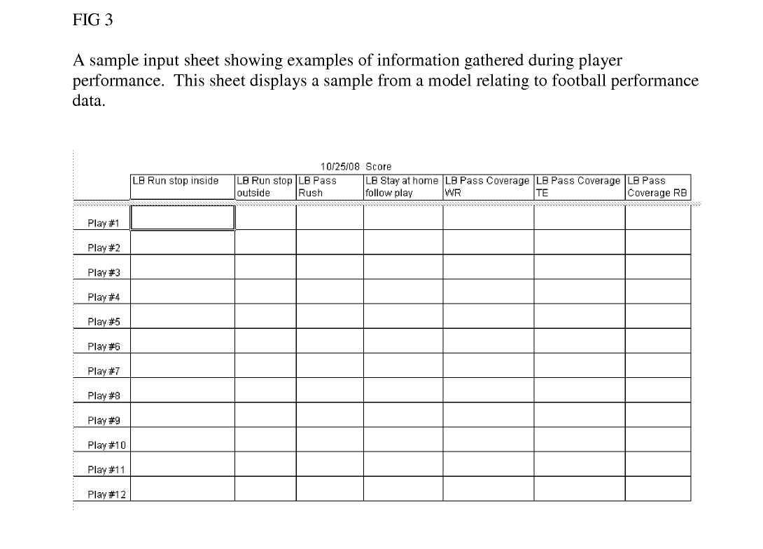

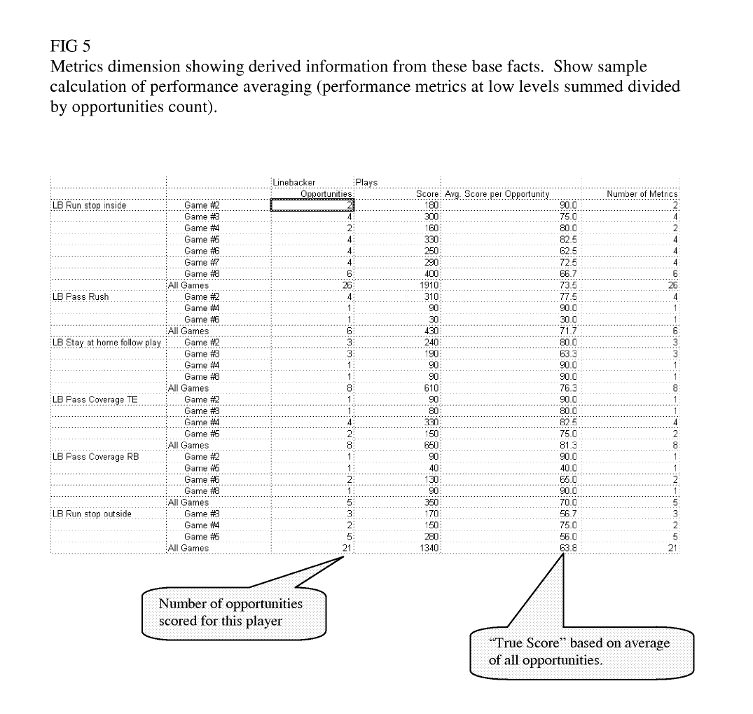

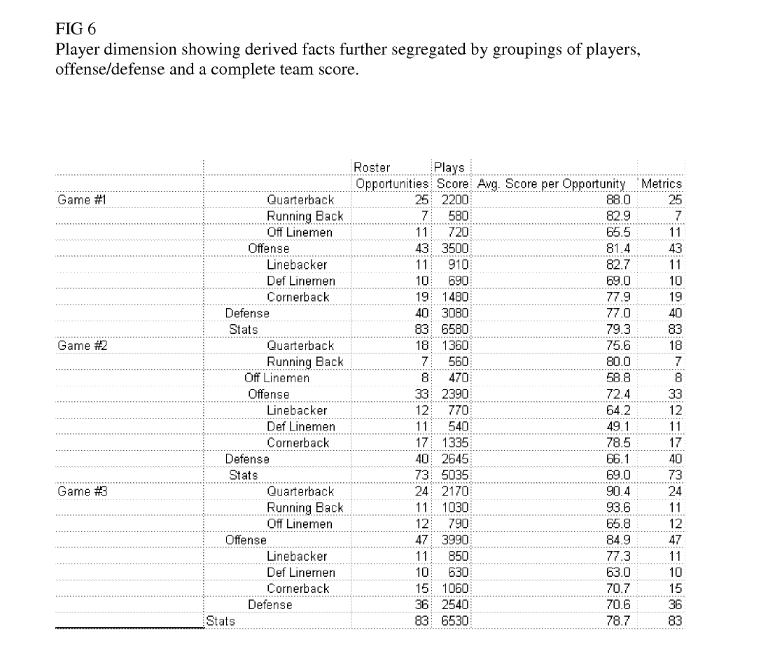

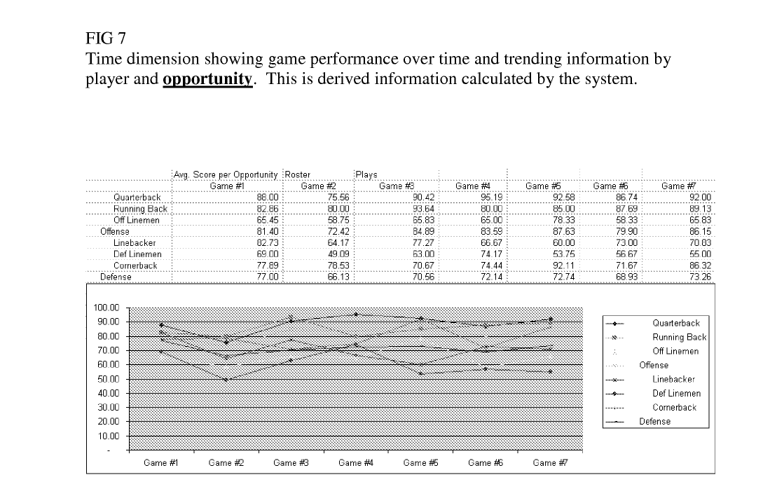

FIGS. 1 through 7 show various preferred embodiments and design elements of the invention. An embodiment of the system takes in information (raw data) which is gathered from a sports activity. This information describes the performance on an event-by-event basis of an individual. The individual can be a participant in a team or independent sporting event that may or may not be scored from a competitive point of view. This play by play information is broken down into different elements or components of performance and based on a best-case scenario. Manifestations of this scoring system may be based on a scale of 1 to 10, 1 to 100 or any other range of numeric values. These individual scores are the base level inputs needed for the system and can be inputted either electronically or manually. (FIG. 3 sample input screen for a football performance model).

Typical manifestations of this system comprise of one or more multi-dimensional database servers (large computers used to store large amounts of digital information) which are used to store and compute the derived information created by the system. Users of the system are typically using a personal computer or other device which is capable of viewing this information (cell phone, PDA). Computer networks transfer the information from the server computers to the client computers as the users request information. Information is organized into views or reports that are used as templates for users to begin their analysis of the derived information.

The facts derived from this system are unique, in that, information calculated by this system does not exist before the system is implemented. For instance, although current manual systems may have the ability to view player performance for a set of instances in an event, it is nearly impossible for these systems to generate trend analysis over long periods of time (entire games, seasons, etc). It is also virtually impossible to perform time based analysis on averages for set of players (an offensive line for a football team for example). One of the core embodiments of this system is the ability to process large amounts of raw data in this fashion and allow users to see these types of trends and other high-level pieces of information.

In the preferred embodiment of this system, the fact (source) data being read in at the lower levels is in electronic form and submitted to the system by the user by either spreadsheet, flat text file or other electronic media (web form). Once this data is in the system, by the nature of the multi-dimensional system, it is aggregated. Aggregations of this data are handled by this system in a very unique way. In most multi-dimensional system embodiments, the data is simply added together (or aggregated). For example, in a retail model, sales for all stores are added together to give totals for a state, region or company. In an analytics model most (if not all) of the core level data cannot be aggregated. If a player scores 100 percent on a certain even and then scores a 90 on a subsequent event the score reported by the system should be an average score (95) not the true aggregation (190). Subsequently, if a certain player does not have a participation in a certain play then their logical score (0 or nothing) should not be held against them. This system takes into account these statistical rules and process the data appropriately.

Other scoring systems such as football passing ratings for quarterbacks also have some severe, essential failures. If a football quarterback makes a perfect throw on a perfectly called play and the receiver fails to catch the ball and instead tips it to an opposing player for an interception the quarterback's “rating” is almost certainly to go down significantly (because it is scored as an interception event only). In the prescribed system, the quarterback would receive a positive score for an accurate pass and completion of the play. The receiver on the other hand, in this example would receive a negative score (and the defensive player would also receive a positive one for a heads up play).

To take the analysis one step further, it is not only important to see average performance over a set of events, but also other longer periods of time. Once you have a true performance measure accurately defined (per the example of the football quarterback above) you then can look at that performance metric, and many others, in conjunction to formulate an accurate, long range performance report. Subsequently, coaches and development personnel can create action plans in the hopes of improving future performance.

Sports analysis is well suited for multidimensional analysis. The dimensions present in an initial manifestation of this system are initial and defined as “Time”, “Games” (or events), “Players” (or participants), and “Measures” (or metrics). The system at a minimum will contain these dimensions, but is flexible enough to accommodate added dimensions and details when necessary.

The time dimension as defined in this system can made up of physical time elements such as years, quarters, months and days. The dimension will allow analysis of players and how they perform during different time periods of the year and will also allow analysis during differing weather conditions and locations.

The games (or events) dimensions allows the analysis of performance over different games. In some sports the events in which players perform is not called “games”, but may be referred to as matches, tests or rounds. The system is flexible enough to handle a myriad of sports and any hierarchical structure which defines groups of these events and in whichever manner they are referred.

The players (or participants) dimension describes every person that is involved in a sporting competition. The system is flexible enough to not only allow metrics on the different types of players, but could also be used in certain circumstances to maintain a constant set of metrics on coaches and/or assistant coaches. A common metric in these systems involves decision making strengths and weaknesses and this dimension is the core elements that allows this type of analysis.

The measures (or metrics) dimension is the key element of this system. This dimension describes the actual core metrics by which every other element of the data will be calculated. At its base, the measures dimension will contain information describing the performance of a participant at its lowest level (or event). At a higher, aggregate level, the measures dimension provides the ability to see total scores for groupings of participants and the entire team. Because of the flexibility of the players dimension it is also possible to measure (against these same common metrics) the performance of participants that may be on different teams. It is also possible to perform metrics analysis in this way to see the participant performance of players jumping from one level of play to another (Triple AAA baseball to major leagues, or Nike tour to PGA tour).

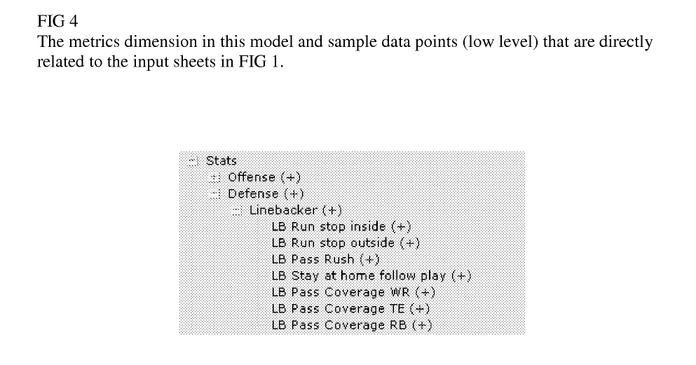

The measures dimension also allows the ability to view averaging of players or groups of players over many events across the other dimensions (see FIG. 4). For example, if a player being evaluated scores a 90 (on a scale of 1 to 100) in one event and then scores a 70 in the next event, most systems would compute a total score of 160. This score of 160 is not informative at all unless the scores can be averaged properly. A core component of this manifestation is the event counter which uniquely identifies the number of instances in which an individual was given the opportunity to record a score. In the above example, since we recorded two instances of a player having the opportunity to record a score then the instance counter would register a value of 2. Thus, the score would be the sum of the two scores (90+70=160) divided by 2 (160/2=80). Now imagine an example such as a football player or basketball player that may over the course of a game have hundreds of instances to perform a certain type of play. A true median score can thus be derived showing a true performance metric of this individual during the course of play of that game for that particular skill set or type of play. Because of the existence of the time dimension, the score is also computed across the time dimensions and all other dimensions present in the system.

As a whole this system allows the analysis of this metric data across time, across different games, across different teams all with the same metrics which enables the base “apples to apples” comparison. This unified model approach gives the decision makers in any sport organization the ability to make intelligent and competent adjustments based on true facts and not speculation.

We claim:

1. A method of deriving analytical facts from a set of data related to individual performance in sporting events including:
individual performance over a course of events;
team performance over a course of events;

2. The method according to claim 1, wherein one or more computations are inferred from the derived data.

3. The method according to claim 1, wherein users are able to query data and certain derived computations are computed at query time by the described system.

4. A method of computing total scores of athletes based on an “aggregated average” of performance thus showing true, high-level performance.
